(19) United States
(12) Patent Application Publication
(10) Pub. No.: US 2004/0165990 A1
(43) Pub. Date: Aug. 26, 2004

(54) Housing assembly for ceiling fan

(76) Inventor: Juin-Jong Lee, Ping-Dong City (TW)

Correspondence Address: BIRCH STEWART KOLASCH & BIRCH, PO BOX 747, FALLS CHURCH, VA, 22040-0747, US

(21) Appl. No.: 10/371,245

(22) Filed: Feb. 20, 2003

(51) Int. Cl. F03B 3/12

(52) U.S. Cl. 416/244 R

(57) ABSTRACT

A housing assembly for fastening an appliance, such as a fan, to a ceiling panel. The housing assembly has a sidewall, pass-through slots on the sidewall and clamping units on the sidewall. Each clamping unit has a base unit, two members, and extensions for aligning the bottom edge of the ceiling. The first member receives a force applied by rotating a screw, and a second arm extends through a slot to make contact with the ceiling panel. Clamping is thus formed by the extensions from the bottom of the ceiling panel, and the second arm from the top of the ceiling panel. As the installer tightens the screw, the screw contacts an indentation in the first member and causes the first member to pivot toward the sidewall. The second member is thus caused to pass through the slot on the housing sidewall, and to engage the top surface of the ceiling.

### ART BACKGROUND

The present invention relates to housing assemblies for installing or fixing an appliance to a ceiling panel or a wall panel, and more particularly to housing assemblies equipped with clamping units for easy installation of fans, or the like, to ceiling panels from underneath the ceiling by the installer. One common appliance suitable for such housing assembly is an exhaust fan, which needs to be installed into a ceiling or wall panel from underneath. Exhaust fans are typically installed after cutting an opening in the ceiling or wall, placing the fan with the housing assembly in the opening, and securing the fan housing from the backside, i.e. from above the ceiling panel. Some installation of the ceiling fan requires the installer to climb up to the roof to finalize the installation, as in the case of a recreational vehicle (“RV”). Consequently, because the installer must place the fan in a location where the backside is accessible, and because the installer is often required to install the fan from above (i.e., the attic or roof top) placement and orientation of the fan, safety of the installer, and ease of installation are compromised.

Accordingly, it is desirable to have a housing assembly that can be installed and fastened from one single location, without having to access the housing assembly from the backside, making the installation safer and more cost efficient.

### SUMMARY OF THE PRESENT INVENTION

Therefore it is an object of the present invention to provide a housing assembly for an appliance that permits the housing assembly to be installed in a ceiling panel from under the ceiling, without having to gain access to the top side of the ceiling or rooftop.

It is also an object of the present invention to provide a housing assembly that makes installation one continuous flow of action, and at the same location, for the installer.

Yet another object of the present invention is to provide a housing assembly that is safer to install than previous models.

Finally another object of the present invention is to provide a housing assembly that can be used to easily fasten many different kinds of appliances to the ceiling.

A housing assembly for an appliance for fastening to a ceiling panel is disclosed. One preferred embodiment of the housing assembly has a housing with a sidewall, pass-through slots on the sidewall, and clamping units on the sidewall with the clamp members positioned to pass through the slots to reach the ceiling panel.

The clamping unit has a base unit that is attached to the sidewall of the housing, a first section pivotally connected to the base unit, and a second curve-shaped section joining the first section to provide a clamp as the first section rotates. A screw is anchored on the base unit and contacts the first section at an indention point. The screw is driven, or tightened, by the installer. The clamping unit is positioned so that the second section can pass through a slot on the sidewall as the first section is driven by the screw. The second end of the second section has a flange to provide more contact surface with the ceiling panel, as well as prevent the second section from slipping out of the slot during initial attachment of the clamping unit to the sidewall.

An installer can cause the second section to pass through the slot and clamp onto the backside of the ceiling panel by tightening the screw. This way, the installer can secure the housing assembly to the ceiling at the same location, without having to gain access to the inside of the ceiling or wall.

### BRIEF DESCRIPTION OF THE DRAWINGS

FIG. 1 is a simplified drawing of an exemplary housing assembly to be placed into the cavity 19 of a ceiling panel 17.

FIG. 2 is a simplified drawing of an exemplary housing assembly with clamping units 55 on the inside of the housing assembly.

FIG. 3 is a simplified drawing of an exemplary clamping unit 55 before it is deployed by the screw 52.

FIG. 4 is a simplified drawing of an exemplary clamping unit 55 after it is deployed by the screw 52.

### DETAILED DESCRIPTION OF THE PREFERRED EMBODIMENT

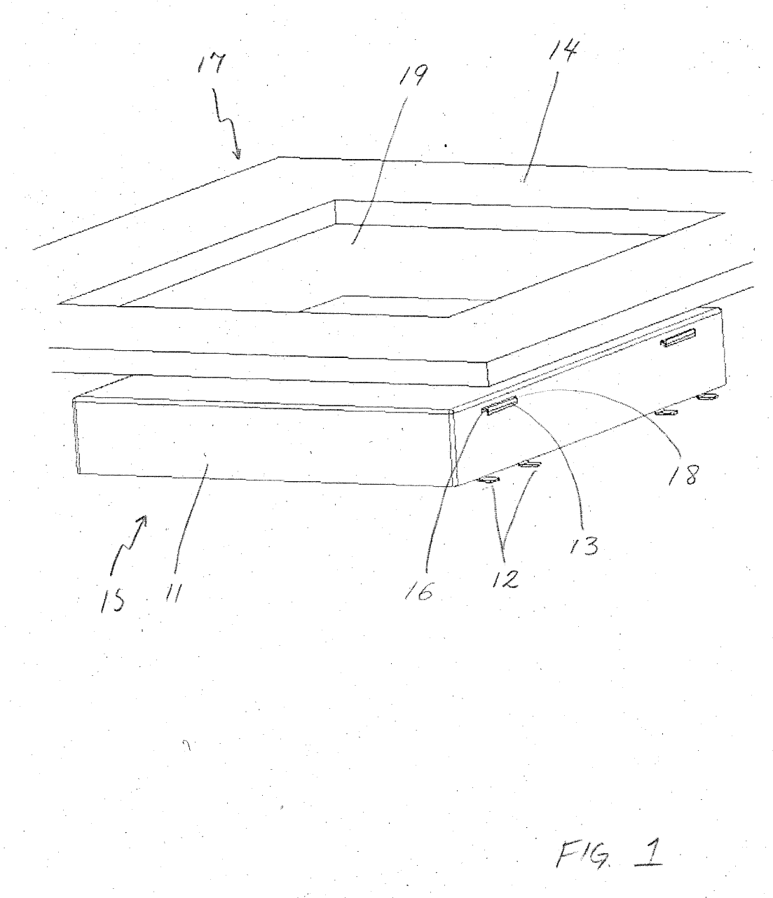

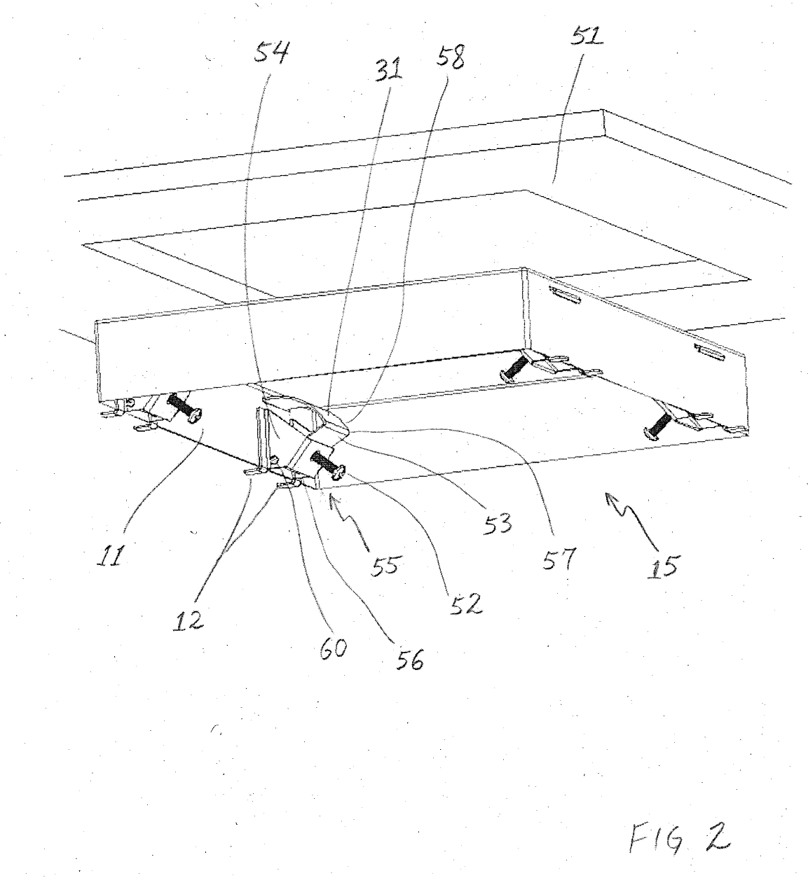

A housing assembly with clamping units for securing a fan, or the like, to a ceiling panel is disclosed. Referring to FIGS. 1 and 2, a simplified diagram of an exemplary housing assembly, positioned to be placed into the cavity 19 of a ceiling panel 17, is illustrated. As shown, the housing assembly in accordance with the present invention has a housing 15, sidewall 11, slots 16 located on the sidewall, and clamping units 55 positioned on the inside of the sidewall. In addition, FIG. 1 shows a top surface 14 of the ceiling panel 17 and the cavity 19, where the housing assembly is to be placed by an installer.

Before the housing unit 15 can be placed into the cavity 19, an end piece 18 of a clamping unit 55 needs to be in a retracted position to allow the housing unit 15 to slide into the cavity 19. The clamping unit extensions 12 extend outwardly from the bottom of the clamping unit 55 toward the outside and away from the clamping units 55. The extensions 12 are designed to help align the housing unit 15 to the ceiling 17, so that the bottom rim of the housing unit 15 is aligned with the bottom edges of the ceiling 17, after it is placed inside the ceiling cavity 19. The clamping unit extensions 12 also work with the end piece 18 to jointly provide clamping of the ceiling panel 17, after the end piece 18 is fully deployed. The flange 13 on the end piece 18 is designed to prevent the end piece 18 from slipping out of the slot 16 when it is retracted, as well as provide more contact and clamping surface when it is deployed.

FIG. 2 further shows the clamping unit 55 from inside of the housing unit 15. The clamping unit 55 has a first section 53 joined with a second section 31, and a base unit 54 supporting the first section 53. The base unit 54 secures the clamping unit 55 to the sidewall 11 of the housing unit 15. After the housing unit 15 has been situated within the ceiling cavity 19, the clamping unit extensions 12 help align the housing unit 15 to be aligned with the bottom of the edges of the ceiling.

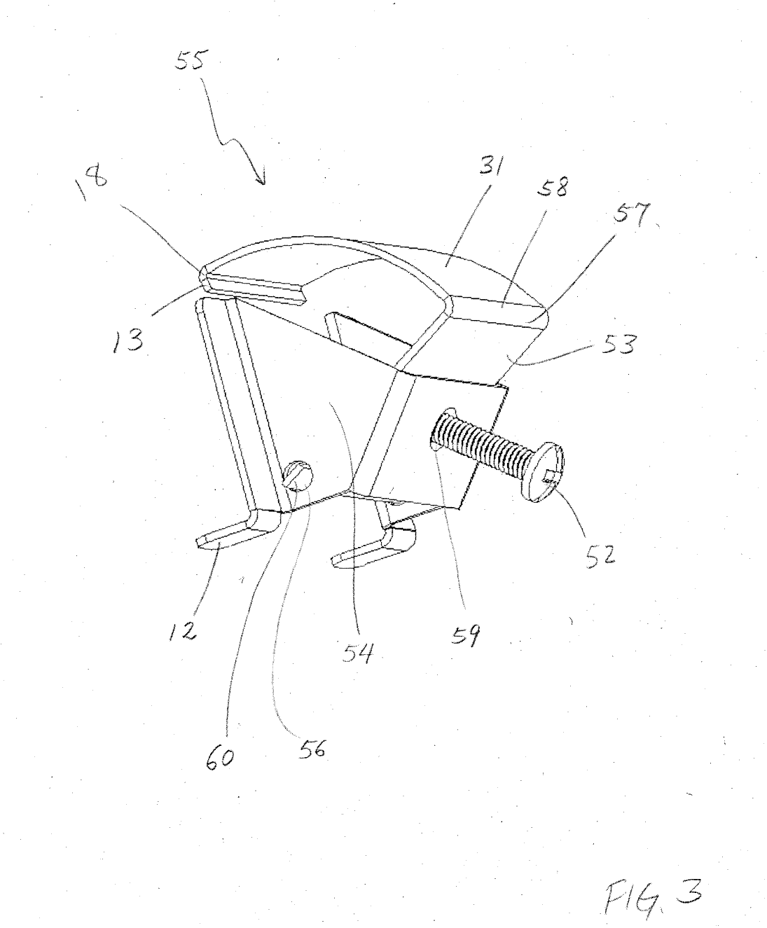

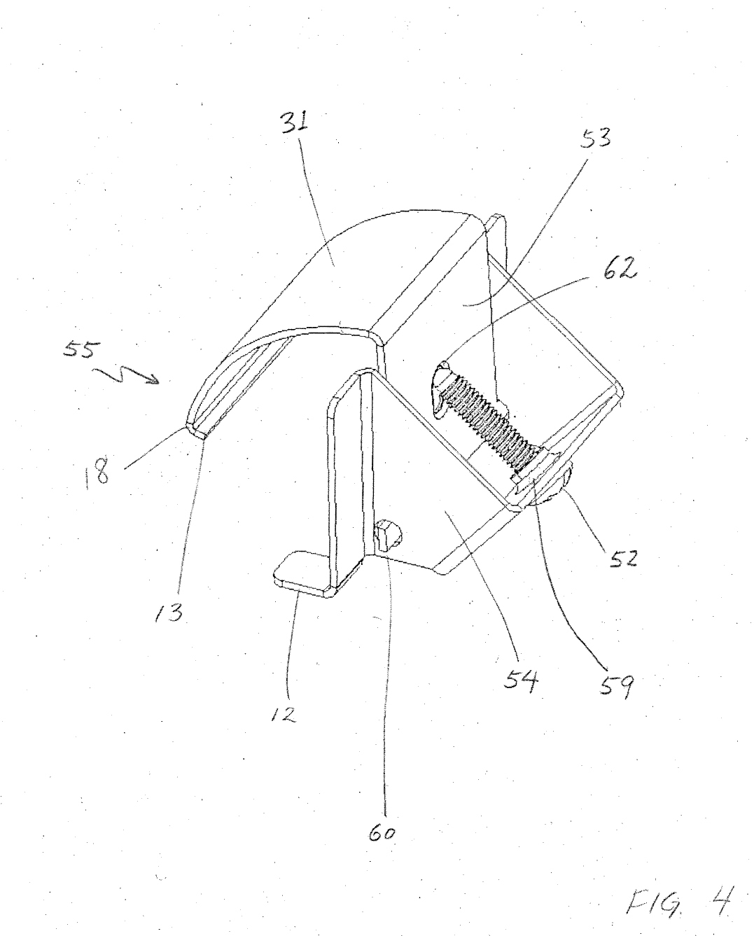

FIGS. 3 and 4 show the clamping unit 55 in more detail. The bottom end 56 of the first section 53 is pivotally connected to the base unit 54 and the top end 57 of the first section is joined with the inside end 58 of the second section 31, forming a predetermined angle between the two sections. The angle between them is such that as the first section is pushed toward the sidewall, the second section passes through the slot 16 and eventually makes contact with the top side surface 14 of the ceiling. As the screw 52 is initially placed through the threaded opening 59 on the base unit 54, the screw 52 engages the first section 53 at the indentation point 62. As the screw is turned through the threaded opening 59, the first section 53 is pushed along the pivot 60 towards the sidewall 11, while the second section moves through the slot 16 until the flange 13 contacts the top surface 14 of the ceiling panel. Further, as the screw 52 is tightened, the flange 13 and the clamping unit extensions 12 create a clamping force between them, thus securing the housing unit 15 to the ceiling panel 17.

As shown in FIGS. 3 and 4, the pivoting extensions 60 from the bottom end 56 of the first second section 53 provide an axis of rotation for the first section to rotate toward the sidewall 11, as the screw 52 is tightened to push against the indentation point 62 of the first section 53. The rotation of the first section 53 is limited and secured by the length of the screw 52. The second section 31, which has a curved shape, deploys as the screw 52 pushes the first section 53 toward the sidewall 11 and becomes fully deployed when the flange 13 contacts the inside ceiling surface 14. As such the housing assembly 15 can be firmly attached to the ceiling panel, without the installer having to change any location. The whole installation can be done in one continuous flow of actions.

Additionally, a spring mechanism (not shown) may be implemented to the first section 53 so that the clamp can be easily retracted when the screw 52 is loosened, by virtue of the compressed or extended spring.

It should be appreciated by those skilled in the art that the housing unit 15 may take different shapes, provided that there are pass-through slots for the clamping units to pass through. Also, the housing may have any number of clamping units attached thereto to ensure proper installation of the housing assembly to the ceiling, or the wall.

While the form of apparatus herein described constitutes a preferred embodiment of this invention, it is to be understood that the invention is not limited to this precise form of apparatus, and that changes may be made therein without departing from the scope of the invention, which is defined in the appended claims.

What is claimed is:

1. A housing assembly for installing an appliance to a ceiling, said ceiling having a top surface and a bottom surface, the housing assembly comprising:
a housing for containing the appliance to be installed;
a sidewall surrounding said housing;
a plurality of pass-through slots on the sidewall at predetermined positions;
a plurality of clamping units positioned on the inside surface of the sidewall, each clamping unit comprising:
a base unit attached to the sidewall;
a screw coupled to the base unit;
a clamping unit having a first section, a curve-shaped second section, a bottom end of the first section being pivotally coupled to the base unit, a top end of the first section joining an inside end of the second section at a predetermined angle, an outside end of the second section being aligned to pass through one of the pass-through slot, the first section being in contact with the screw such that as the screw is tightened, the screw pushes the first section toward the sidewall and causes the second section to make contact with the top surface of the ceiling.

2. The housing according to claim 1, wherein the outside end of the second section has a flange for contacting the top surface of the ceiling when the second section is deployed.

3. The clamping unit of claim 2, wherein the base unit has an extension for supporting and aligning the housing with the bottom surface of the ceiling.

4. The housing of claim 1, wherein the first section has two protrusions at its bottom end, which extend through two holes in the base unit to allow the first section to pivot along an axis formed by the two protrusions.

5. The housing of claim 1 wherein the appliance is a light.

6. The housing of claim 1 wherein the appliance is a fan.

7. A housing assembly for installing a fan to a wall panel, the wall panel having a top and bottom surface, the housing assembly comprising:
a housing means for containing the appliance to be installed;
a sidewall surrounding said housing means;
a plurality of pass-through slots on the sidewall at predetermined positions;
a plurality of fastener units positioned on the inside surface of the sidewall, each fastener unit comprising:
a base means for attaching the fastener unit to the sidewall and for aligning the sidewall to the bottom surface of the wall panel;
an activation means coupled to the base means;
a clamping means coupled to the base means and the activation means, for being driven by the activation means to move from a retracted position, pass through the pass-through slot, to a deployed position to clamp the top surface of the wall panel.

8. The housing assembly according to claim 7, wherein the clamping means comprises a first arm and a curve-shaped second arm, forming a predetermined angle, such that when the first arm is pushed by the activation means, the second arm is move through the pass-through slot to contact the top surface of the wall panel.

9. The housing assembly according to claim 8, wherein said second arm has a flange for making more contact surface with the top surface of the wall panel.

10. The housing assembly according to claim 7, wherein the base means has an extension for aligning the sidewall to the bottom surface of the wall panel.

11. A housing assembly for installing an appliance to a ceiling, said ceiling having a top surface and a bottom surface, the housing assembly comprising:
a housing for containing the appliance, the housing having a sidewall, the sidewall having a plurality of pass-through slots at predetermined locations on the sidewall;
a plurality of clamping units on the sidewall, comprising:
a base means for attaching the clamping unit to the sidewall and for aligning the sidewall to the bottom surface of the ceiling;
an activation means coupled to the base means;
a first arm pivotally connected to the base means, the first arm disposed to rotate toward and away from the sidewall as pushed by the activation means;
a curve-shaped second arm connected to the first arm, the second arm passing through the pass-through slot and gradually making contact with the top surface of the top surface of the ceiling, as the first arm rotates toward the sidewall.

12. The clamping unit of claim 11 wherein the activation unit is a screw, in contact with the first arm and passing through a threaded opening on the base means.

13. The second section of claim 11 wherein the second arm has a flange at its distal end for contacting the top surface of the ceiling.

14. The housing of claim 11 wherein the appliance is a light.

15. The housing of claim 11 wherein the appliance is a fan.
